(19) United States
(12) Patent Application Publication
(10) Pub. No.: US 2026/0084889 A1
(43) Pub. Date: Mar. 26, 2026

(54) PAPER-BASED MULTILAYER PACKAGING FILMS

(71) Applicant: AMCOR FLEXIBLES NORTH AMERICA, INC., NEENAH, WI (US)

(72) Inventors: Jean-Marie BONIFACY, La Couronne (FR); Donatien COULON, Hommarting (FR)

(21) Appl. No.: 19/112,413

(22) PCT Filed: May 16, 2023
(86) PCT No.: PCT/US2023/022388

§ 371 Date: Mar. 17, 2025

Related U.S. Application Data
(63) Continuation of application No. PCT/US2022/045322, filed on Sep. 30, 2022.

(30) Foreign Application Priority Data
Sep. 30, 2022 (WO) PCT/US2022/045322

(51) Int. Cl. B65D 85/76; B32B 3/26; B32B 7/14; B32B 27/10; B32B 27/32; B32B 37/12; B32B 38/00

(52) U.S. Cl. CPC B65D 85/76; B32B 3/266; B32B 7/14; B32B 27/10; B32B 27/32; B32B 37/1292; B32B 38/145; B32B 2250/02; B32B 2255/02; B32B 2255/26; B32B 2262/062; B32B 2307/518; B32B 2307/70; B32B 2307/724; B32B 2307/75; B32B 2317/122; B32B 2323/10; B32B 2439/70

(57) ABSTRACT

This disclosure relates to multilayer packaging films and methods of producing the same. The multilayer packaging films are paper-based and have a total composition comprising greater than or equal to 80%, by weight, of a paper component. The multilayer packaging films are easily recyclable by repulping yet retain high-performance packaging characteristics including maintaining permeability performance and controlling the rate of ripening of a living food product, such as a cheese product. For example, the cheese product may include, but is not limited to, a soft cheese and/or a respirable cheese.

### TECHNICAL FIELD

The present disclosure is related to paper-based packaging films and methods of producing the same. Embodiments of the present disclosure are directed to paper-based multilayer packaging films having greater than or equal to 80%, by weight, of a paper component, that are suitable for packaging a food product, such as a cheese product.

### BACKGROUND

The goal of increasing recyclability of paper-based multilayer packaging films becomes challenging when attempting to form films that are intended to protect a packaged product, such as a food product, from its external environment. Traditionally, a packaged product is protected by forming a multilayer film having a plurality of specific layers. As performance demands increase, the multitude of layers or thickness of the layers in the multilayer film increase, working against the recyclability of the structure as the paper content decreases on a percentage basis.

Often, when high performance is desired from paper-based multilayer packaging films, relatively high amounts of additional non-paper materials are added to the paper-based packaging films. To maintain recyclability of the paper-based packaging film, the paper component thickness and/or weight is increased in order to attain the paper content required for designating the packaging material “recyclable.”

Additionally, for food products, it is desirable to form packaging films that regulate and optimize air permeability, gas permeability, water vapor permeability, and water absorption capacity between the food product and the external environment during ripening of the food product within the packaging. However, current multilayer films that provide some desirable permeability properties typically have relatively high amounts of additional non-paper materials added to the films, such as paraffin, whose role is to prevent molds present on a cheese product from sticking to the multilayer film. Use of paraffin in the food packaging industry is being discouraged due to potential health issues stemming from its use. Therefore, it is desirable to avoid the presence of paraffin when developing food packaging.

Without contesting the associated advantages of the state-of-the-art systems, there exists a need for paper-based multilayer packaging films that are paraffin-free, are suitable for recycling, maintain permeability performance, and possess the ability to control the rate of ripening of a food product, such as a cheese product.

### SUMMARY

Embodiments of the disclosure are directed to flexible, paper-based multilayer packaging films which possess high permeability performance and the ability to control the rate of ripening a food product, such as a cheese product, while maintaining recyclability in a paper recycling (repulpability) process. As used herein, the terms “paper-based multilayer packaging film(s)” and “paper-based packaging film(s)” may be used interchangeably. The paper-based multilayer packaging films comprise a paper component and include minimal amounts of non-paper materials. The minimal amounts of non-paper materials may be easily removed from the paper-based packaging films such that the paper recycling (repulpability) process would not be hindered.

The multilayer packaging film is intended for packaging food products, including but not limited to cheese products. The multilayer packaging film may be used for packaging a moisture sensitive cheese product, the packaging controlling the moisture and/or the exudates originating from the product after it has been packaged. For example, the cheese product may include, but is not limited to, a soft cheese and/or a respirable cheese.

In some embodiments, the paper-based multilayer packaging film comprises a polymer layer facing towards the food product to be packaged, a water-absorbing layer comprising a paper component, and an adhesive layer attaching the polymer layer to the water-absorbing layer.

In some embodiments, a total composition of the paper-based multilayer packaging film comprises greater than or equal to 80%, by weight, of the paper component. In some embodiments, a total composition of the paper-based multilayer packaging film comprises greater than or equal to 85%, or greater than or equal to 90%, by weight, of the paper component.

In some embodiments, the paper component has a basis weight in a range of from 15 g/m² to 100 g/m². In some embodiments, the basis weight of the paper component is in a range of from 20 g/m² to 60 g/m².

In some embodiments, the paper-based multilayer packaging film comprises less than or equal 20%, less than or equal to 15%, or less than or equal to 10%, by weight, of non-paper materials. The polymer layer, the adhesive layer, and/or the printing layer may include non-paper materials.

In some embodiments, the water-absorbing layer comprising the paper component has a water absorption rate in a range of from 0.01 g/m² to 30 g/m² as measured using the method disclosed in the COBB test C3600.

In some embodiments, the polymer layer has a plurality of microcuts and the multilayer packaging film has an air permeability in a range of from 0.1 mL/min Bendtsen to 200 mL/min Bendtsen, including all ranges and subranges therebetween, measured using the method disclosed in the international standard ISO 5636-3. Exemplary air permeabilities include 10 to 200 mL/min Bendtsen, 15 to 200 mL/min Bendtsen, 20 to 200 mL/min Bendtsen, 50 to 200 mL/min Bendtsen, 0.1 to 50 mL/min Bendtsen, 0.1 to 20 mL/min Bendtsen, 0.1 to 15 mL/min Bendtsen, 0.1 to 10 mL/min Bendtsen, 0.1 to 5 mL/min Bendtsen, 0.1 to 4 mL/min Bendtsen, 0.1 to 3 mL/min Bendtsen, 0.1 to 2 mL/min Bendtsen, 0.1 to 1 mL/min Bendtsen and 0.1 to 0.5 mL/min Bendtsen. The air permeability of the multilayer packaging film may vary based on the type of food product to be packaged. For example, the multilayer packaging film has an air permeability in a range of from 0.1 mL/min Bendtsen to 0.5 mL/min Bendtsen for packaging some types of food products, such as a blue mould soft cheese with a white mould surface, as an example. In other embodiments, the multilayer packaging film has an air permeability in a range of from 50 mL/min Bendtsen to 200 mL/min Bendtsen for packaging some types of food products, such as a middle hard cheese with surface smear, as an example.

In some embodiments, the plurality of microcuts is randomly distributed. As used herein, the term “randomly distributed” means that the distance between two adjacent microcuts, taken in the plane of the polymer layer, is not constant. At least over a surface of the internal layer having an area substantially equal to that of the active surface of the tool used for making the microcuts, the microcuts do not define a pattern that is repeated periodically. The microcuts may define any suitable shape. The dimensions of the microcuts in the plane of the polymer layer may vary from one microcut to the other.

In some embodiments, the plurality of microcuts define a pattern where the distance between one or more adjacent microcuts, taken in the plane of the polymer layer, is substantially not constant, such that dimensions of the microcuts in the plane of the polymer layer may still vary from one microcut to the other. As used in this context, “substantially not constant” means that the plurality of microcuts as a whole do not define a pattern that is repeated periodically, but that a small number of adjacent microcuts of the plurality of microcuts (e.g., less than 10%, less than 5%, or less than 1% of the plurality of microcuts) define a pattern that is repeated periodically.

In some embodiments, the microcuts include a plurality of perforations that fully penetrate the polymer layer, i.e., the perforations extend through a thickness of the polymer layer. In some embodiments, the microcuts comprise a plurality of abrasions that do not fully penetrate the polymer layer, i.e., the abrasions have a depth that is smaller than the thickness of the polymer layer. In some embodiments, the microcuts are of varying depths including a plurality of perforations that extend through a thickness of the polymer layer and a plurality of abrasions whose length is smaller than the thickness of the polymer layer. The plurality of perforations and the plurality of abrasions advantageously allow for evacuation of humidity from the food product (e.g., a cheese product). Advantageously, the paper-based multilayer packaging films described herein absorb the water from the cheese product. In some embodiments, one or more of the plurality of perforations or the plurality of abrasions are randomly distributed. In some embodiments, the plurality of abrasions is randomly distributed. In addition to random distribution of the microcuts, the depth of penetration of the microcuts is random as well.

In some embodiments, the polymer layer has a thickness in a range of from 2 μm to 10 μm. In some embodiments, the polymer layer comprises one or more of an oriented polyethylene (OPE) film, an oriented polypropylene (OPP) film, an oriented polyester-based polymer film, or a compostable polymer film. Examples of a compostable polymer film include, but are not limited to, PBAT polymers, PLA polymers, PBT polymers, or blends of these. In some embodiments, the polymer layer is a biaxially oriented polypropylene (BOPP) film. The oriented polyethylene (OPE) film, the oriented polypropylene (OPP) film, the oriented polyester-based polymer film, and/or the compostable polymer film may be a bio-based polymer film.

In some embodiments, the polymer layer comprises a plurality of layers. In some embodiments, the adhesive layer comprises one or more a solvent-based adhesive, water-based adhesive, or solventless adhesive. In some embodiments, the adhesive layer has a dry basis weight in a range of from 0.1 g/m² to 6 g/m², including all ranges and subranges therebetween. In some embodiments, the adhesive layer has a dry basis weight in a range of from 0.3 g/m² to 5 g/m². In some embodiments, the adhesive layer has a dry basis weight in a range of from 0.5 g/m² to 4 g/m².

In some embodiments, the adhesive layer is in direct contact with the water-absorbing layer and the polymer layer.

In one or more embodiments, the adhesive layer is patterned. For example, when the adhesive layer has a dry basis weight that is lower, such as less than or equal to 0.3 g/m², the adhesive layer is patterned. In one or more embodiments, surface area coverage (e.g., the surface area covered by the adhesive layer) may be in a range of from 2% and 100%, such as in the range of from 20% to 50%, as an example. Without intending to be bound by theory, it is thought that using an adhesive layer that is patterned helps with recycling, lowers material use and is an advantage of adhesive lamination over extrusion lamination (which must be full coverage by nature of the process).

In some embodiments, the paper-based multilayer packaging film comprises a printing layer on an outer surface (i.e., an exposed surface) of the water-absorbing layer. In some embodiments, the printing layer is facing away from the food product to be packaged.

Additional embodiments are directed to a method of producing a paper-based multilayer packaging film. In some embodiments, the method comprises producing a polymer layer; abrading the polymer layer; and attaching the polymer layer to a water-absorbing layer by an adhesive lamination process to yield the multilayer packaging film. In some embodiments, the adhesive lamination process is performed prior to abrading the polymer layer. In other embodiments, the adhesive lamination process is performed after abrading the polymer layer.

Further embodiments are directed to a package formed from the multilayer packaging film. In one or more embodiments, a package is formed from the multilayer packaging film by wrapping the multilayer packaging film around the food product, such as a cheese product, and tacking the polymer layer to the outer surface of the water-absorbing layer. Stated differently, where the polymer layer defines the interior surface of the package and is in direct contact with the cheese product, and the water-absorbing layer or printing layer defines the exterior surface is facing away from the cheese product, the polymer layer and the water-absorbing layer or printing layer overlap and are in contact with each other when wrapping the multilayer packaging film around the food product. For example, the wrapped package having the cheese product therein may include a sticker on the outer surface of the package. In other embodiments, the wrapped package having the cheese product therein may include a sticker on the outer surface of the package and may then be placed in a carton box.

### BRIEF DESCRIPTION OF THE DRAWINGS

The disclosure may be more completely understood in consideration of the following detailed description of various embodiments of the disclosure in connection with the accompanying Figures, in which:

FIG. 1 illustrates a process flow diagram of a method of producing a paper-based multilayer packaging film according to one or more embodiments;

FIGS. 2 and 3 illustrate schematic cross-sectional views of different embodiments of a paper-based multilayer packaging film;

FIG. 4 illustrates various embodiments of a patterned adhesive layer of the paper-based multilayer packaging film shown in FIGS. 2 and 3; and

FIG. 5 illustrates a schematic cross-sectional view of a package including the paper-based multilayer packaging film shown in FIGS. 2 and 3.

The Figures show some, but not all embodiments. The elements depicted in the Figures are illustrative and not necessarily to scale, and the same (or similar) reference numbers denote the same (or similar) features throughout the Figures.

### DETAILED DESCRIPTION

Provided herein are paper-based multilayer packaging films that overcome shortcomings of previously provided films. The paper-based packaging films of the present disclosure are uniquely designed to deliver a critical combination of 1) recyclability (high paper content), 2) ease of package converting, 3) maintain permeability performance, and 4) controlling the rate of ripening of a food product, such as a cheese product. Additionally, this unique combination of layers and materials allows for an overall high paper content and low thickness.

The paper-based packaging films may include additional layers. The combination of these materials can be described as a multilayer film (e.g., a structure or a laminate). The term “layer”, as used herein, refers to a building block of films. A layer is a structure of a single material type or a homogeneous blend of materials. A layer may be a single polymer, a blend of materials within a single polymer type or a blend of various polymers. A layer may contain metallic materials and may have additives. Layers may be continuous with the film or may be discontinuous or patterned. Both layers and films have a relatively insignificant thickness (z-direction) as compared to their respective length and width (x-y direction).

As described herein, the “total composition” of the paper-based packaging film refers to all materials encompassed therein. The total composition of the paper-based packaging film may include greater than or equal to 80%, by weight, of the paper component. The total composition of the paper-based packaging film may include greater than or equal to 85%, by weight, of the paper component. The total composition of the paper-based packaging film may include greater than or equal to 90%, by weight, of the paper component. For example, the total composition of the paper-based packaging film may comprise in a range of from greater than or equal to 80% to greater than or equal to 90% of the paper component, by weight, including all values and subranges therebetween.

The total composition of the paper-based packaging film may include less than or equal to 20%, less than or equal to 15%, less than or equal to 10%, less than or equal to 5%, less than or equal to 4%, less than or equal to 3%, less than or equal to 2%, or less than or equal to 1%, by weight, of non-paper materials. The polymer layer, the adhesive layer, and/or the printing layer may include non-paper materials. For example, the total composition of the paper-based packaging film may comprise, by weight, 90% of the paper component and 10% non-paper materials. In another example, the total composition of the paper-based packaging film may comprise, by weight, in a range of from 80% to 90%, including all values and subranges therebetween of the paper component and in a range of from 10% to 20%, including all values and subranges therebetween, of non-paper materials.

The paper-based multilayer packaging films described herein include a polymer layer defining an interior surface of the film. The paper-based multilayer packaging films described herein include an adhesive layer attaching the polymer layer to the water-absorbing layer. In some embodiments, the adhesive layer is in direct contact with the water-absorbing layer and the polymer layer. As used herein, the term “adjacent” means that the items, such as layers of a film, are near each other, with or without intervening material, such as an adhesive layer. As used herein, the term “directly adjacent,” “directly connected” or “in direct contact with” means that the items are in contact with each other, without intervening material. In some embodiments, the polymer layer is attached in its entirety to the water-absorbing layer. As used herein, the term “in its entirety” means that, for example, less than or equal to 1% or less than or equal to 0.5% of the polymer layer is not attached to the water-absorbing layer. In some embodiments, the adhesive layer is patterned, which will be discussed in further detail below.

In some embodiments, a portion of the polymer layer is attached to the water-absorbing layer. As described herein, “a portion of the polymer layer is attached to the water-absorbing layer” means that the polymer layer remains, at least, partially attached to the water-absorbing layer such that the polymer layer remains undamaged and attached to the water-absorbing layer during production/processing. Stated differently, the polymer layer may be partially attached to the water-absorbing layer or entirely attached to the water-absorbing layer. Additionally, in some embodiments, the polymer layer is coextensive with the water-absorbing layer. As described herein, “coextensive” means that one or more layers may occupy the same area.

As used herein, the term “patterned” means that the layer (e.g., the adhesive layer) is discontinuous with the multilayer packaging film. In other words, the layer (e.g., the adhesive layer) covers only some portion of the area of the multilayer packaging film. In some embodiments, the patterned layer can define any suitable drawings, graphics, and/or textual terms, and/or define a pattern having any suitable shape or shapes, including, but not limited to, dots, points, lines, crossed-lines, diamonds, or checkerboards. The pattern of the adhesive may or may not be visible through the polymer film. The pattern of the adhesive may or may not be visible through the paper component. The patterned adhesive may accentuate the overall appearance of the packaged product. In some embodiments, the adhesive layer is discontinuous with the polymer layer upon which it is applied. The adhesive layer may be applied over greater than or equal to 5%, greater than or equal to 10%, or greater than or equal to 15% of the surface of the polymer layer. The adhesive layer may be applied over less than or equal to 30%, less than or equal to 25%, or less than or equal to 20% of the polymer layer.

As used herein, the term “printing layer” or “printed indicia layer” refers to a layer or series of sub-layers that have been printed onto a film. The layer or sub-layers may include pigment containing materials (i.e., colored ink), protective layers (i.e., over-lacquer) and ink receptive primers. Over-lacquer may protect a printed pigment layer and may improve the appearance of surface of the film. Each of the printing layer(s) may be independently continuous with the other layers of the film or independently discontinuous (i.e., patterned). Specifically, a printing layer may include one or more continuous sub-layers of white pigmented print and one or more patterned sub-layers including other colors, thus producing the visible graphics for the multilayer packaging film. Printing of the printing layer may be done by any known printing method including, but not limited to, flexographic gravure printing, rotogravure printing, gravure coating, and digital printing methods. Sub-layers within the printing layer may be applied by the same process or using different types of processes. In one or more embodiments, the printing layer is free or substantially free of pigment material. The printing layer may include varnish and/or ink superimposed onto the external surface of the paper component. The varnish is intended for protecting the external surface of the paper component against aggressions from the environment. The varnish may also be used to provide a glossy or matte aspect to the external surface.

All layers and films described herein have two major surfaces, opposite each other, defined by the x-y plane. The term “outer layer” as used herein refers to one or more layers of the paper-based packaging film that are on either major surface of the film, i.e., the layers that are not between two other layers of that film. As described herein, the paper-based packaging film has an exterior surface that becomes the exterior of a package in which the film is used. When formed into a package, the exterior surface of the film is exposed to the environment. In one or more embodiments, the water-absorbing layer defines the exterior surface of the film, is facing away from the packaged product, and is exposed to the environment. In one or more embodiments, the printing layer defines the exterior surface of the film, is facing away from the packaged product, and is exposed to the environment. As described herein, the paper-based packaging film has an interior surface that becomes the interior of a package in which the film is used. When formed into a package, the interior surface is exposed to the packaged product. In one or more embodiments, the polymer layer defines the interior surface of the film and is exposed to the packaged product.

One or more of the layers or films of the paper-based packaging films may be coextensive with one another. As described herein, “coextensive” means that one or more layers may occupy the same area.

Referring again to the paper component, the paper component is an outer layer of the paper-based packaging film that is located at an exterior surface of the paper-based packaging film. In some embodiments, the paper component includes additional components adjacent to or on the exterior surface of the paper component, such as ink or over lacquer. These additional components may cover a portion of the exterior surface or the entire exterior surface.

The “paper component” may be any type of paper that can be processed in a paper recycling (repulpability) process. As used herein, the term “paper component” may be described with respect to an amount of cellulose fibers in the paper component that can be recovered by a repulping process. For example, the paper component comprises or consists essentially of cellulose fibers. As used in this context, “consisting essentially of” means that the total composition of the paper component includes greater than or equal to 95%, greater than or equal to 98%, greater than or equal to 99%, greater than or equal to 99.9% or 100% cellulose fibers. Accordingly, in embodiments where a total composition of the paper-based packaging film comprises greater than or equal to 80%, or greater than or equal to 90%, by weight, of the paper component, the total composition of the paper-based packaging film comprises greater than or equal to 80%, or greater than or equal to 90%, by weight, of the cellulose fibers.

In some embodiments, the paper component has a basis weight in a range of from 15 g/m² to 100 g/m², including all values and subranges therebetween, including in a range of from 20 g/m² to 60 g/m². Lower paper component weight is possible, while retaining easy recyclability, because the additional components are minimized. Examples of paper components that may be useful in the paper-based packaging films include, but are not limited to, kraft paper, and bleached paper. The paper component may be coated (i.e., clay coated) or uncoated. Examples of commonly used paper in packaging that would be acceptable in the paper-based packaging films described herein include machine glazed bleached kraft paper (MGBK), one-side clay-coated paper (C1S) and two-side clay-coated paper (C2S) although less common papers providing improved mechanical or barrier performance by using specialty fibers or additives could also be a part of the paper-based packaging films described in this application. The paper component, as described herein, does not include non-repulpable paper or paper that has been treated with a wet strength treatment. Examples of non-repulpable paper that would not be useful in the paper-based packaging films described herein include, but are not limited to, wet strength paper or wax paper. In embodiments where the paper component is coated, the total composition of the paper component has greater than or equal to 80%, or greater than or equal to 90% cellulose fibers.

As used herein, the term “basis weight” is used to refer to the amount of material by weight is present in a predetermined area of a film or layer. Typically, the area defined is a square meter, but any area can be used. The area is defined in the length-width (i.e., x-y direction) of the film or layer. A material of a given thickness (z-direction) and density, has a specific weight when covering a defined area (i.e., a square meter). Basis weight is a commonly used measurement of weight for paper because the density of paper can vary widely. Stated differently, measuring paper by thickness in the z-direction can be difficult. Materials that are applied in discontinuous layers, such as a patterned material, can also be defined by basis weight. In the case of patterns, the basis weight refers to the amount of material by weight that is present when covering a defined area. The use of basis weight to measure weight of materials such as paper and patterned materials is common in the film converting industry.

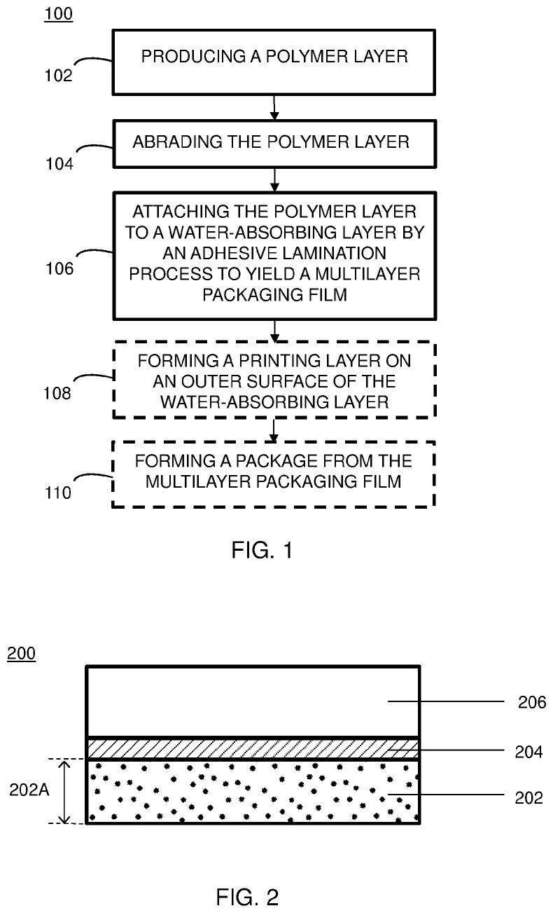

FIG. 1 illustrates a process flow diagram of a method 100 of producing a multilayer packaging film according to one or more embodiments. The method 100 comprises: producing a polymer layer (operation 102); abrading the polymer layer (operation 104); and attaching the polymer layer to a water-absorbing layer by an adhesive lamination process to yield a multilayer packaging film (operation 106). In some embodiments, the adhesive lamination process (operation 106) is performed prior to abrading the polymer layer (operation 104). In some embodiments, the adhesive lamination process (operation 106) is performed after abrading the polymer layer (operation 104). In some embodiments, the method 100 optionally includes forming a printing layer on an outer surface of the water-absorbing layer (operation 108) and/or forming a package from the multilayer packaging film (operation 110).

The polymer layer may be produced at operation 102 by any suitable method known to the skilled artisan.

The adhesive lamination process at operation 106 includes laminating using one or more of a solvent-based adhesive, water-based adhesive, or solventless adhesive to form an adhesive layer. Unless otherwise specifically indicated, an adhesive layer may have any suitable composition that provides a desired level of adhesion with the one or more surfaces in contact with the adhesive. Solvent-based adhesives include polyurethane-based adhesives such as two-part polyurethane adhesives, including but not limited to those with solids content greater than 30%, by weight. Specific examples of water-based adhesives include, but are not limited to, Swift@tak 9119X or Robond™ L280. A specific example of a solventless adhesive includes, but is not limited to, MOR-FREE™ ELM 415A. Without intending to be bound by theory, the adhesive layer materials are believed to have negligible effect on the thickness of the film.

Embodiments of the disclosure advantageously provide paper-based multilayer packing films including an adhesive layer that is water sensitive. As used herein, the term “water sensitive” means that upon prolonged exposure to or immersion in liquid water, the adhesive layer loses its adhesive and/or cohesive properties, thus enabling the delamination (i.e., separation) of the paper component from the rest of the paper-based multilayer packaging film structure during a repulping process. Examples of materials that may be used within an adhesive layer between the water-absorbing layer and the polymer layer include, but are not limited to, latex/casein blends, starch, sugar derivatives, cellulose, amino resin, (poly) acrylate, polyvinyl alcohol (PVOH), polyvinyl acetate, polyacrylic acid, maleic acid-modified ethylene copolymers, methylcellulose, carboxy-methylcellulose, carboxy-functional polyesters, polyethylene succinate, polybutylene succinate, ionomers or hydrophilic polyurethane.

The use of the adhesive lamination process instead of an extrusion lamination process, for example, advantageously provides the necessary bonding between the water-absorbing layer and the polymer layer by using less material, thus more easily meeting the “recyclable” criteria of high paper fiber content.

Reducing the thickness of the polymer layer therefore makes it possible to significantly increase the percentage of paper fiber content of the multilayer packaging film and therefore, allows for increasingly high paper fiber content objectives to be met in order to be recycled in a paper recycling process.

The transition from the extrusion coating process to the lamination process advantageously leads to the use of thin bi-oriented polymer films providing an improvement in the mechanical strength of the final multilayer packaging film.

The using of bi-oriented thin polymer, for example will allow to have the same natural barrier (without randomly distributed microcuts) than an extrusion coated layer with a lower grammage and/or thickness.

The use of the adhesive layer that is not entirely on the surface (e.g., a patterned adhesive layer) between the water-absorbing layer and the polymer layer, such as, by adhesive lamination using lines or points, will also reduce the quantity of adhesive. It is thought that reducing the quantity of adhesive will achieve a better recyclability of the multilayer packaging film because a reduced amount of paper fiber content will be attached to the thin polymer layer.

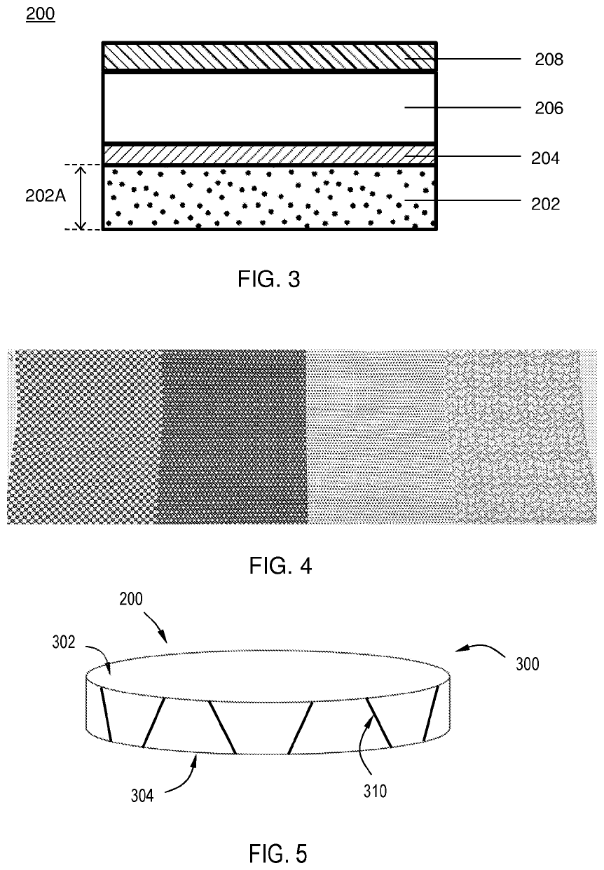

FIGS. 2 and 3 are schematic cross-sectional views of different embodiments of a multilayer packaging film 200. The multilayer packaging films 200 illustrated in FIGS. 2 and 3 may be formed by method 100.

FIG. 2 illustrates a multilayer packaging film 200 having a polymer layer 202 facing towards a food product (not illustrated) to be packaged, a water-absorbing layer (e.g., a paper component) 206, and an adhesive layer 204 attaching the polymer layer 202 to the water-absorbing layer 206.

FIG. 3 illustrates a multilayer packaging film 200 having a polymer layer 202 facing towards a food product (not illustrated) to be packaged, a water-absorbing layer (e.g., a paper component) 206, an adhesive layer 204 attaching the polymer layer 202 to the water-absorbing layer 206, and a printing layer 208 on an outer surface of the water-absorbing layer 206.

Each of the layers/films illustrated in FIGS. 2 and 3 have a thickness measured in the z-direction. As described herein, measuring the adhesive layer and the water-absorbing layer by thickness in the z-direction can be difficult. Accordingly, the weight measure of materials such as paper and patterned materials (i.e., the adhesive layer) may be expressed in terms of basis weight. In some embodiments, the polymer layer 202 has a thickness 202A in a range of from 2 μm to 10 μm. In some embodiments the polymer layer 202 has a thickness 202A in a range of from 2 μm to 8 μm, or in a range of from 2 μm to 6 μm.

In the illustrated embodiments of FIGS. 2 and 3, the adhesive layer 204 is in direct contact with the water-absorbing layer 206 and the polymer layer 202.

As mentioned previously, the paper-based packaging film may also include ink located on the exterior surface of the paper-based packaging film. The type of ink and amount of ink can be varied within ranges agreeable with local paper recycling guidelines.

FIG. 4 illustrates a top view of various embodiments of a patterned adhesive layer of the paper-based multilayer packaging film shown in FIGS. 2 and 3. The patterned adhesive layer may include the adhesive layer 204. In the illustrated embodiments of FIG. 4, the patterned adhesive layers (e.g., adhesive layer 204) define patterns having checkerboards, circles of adhesive areas, circles of non-adhesive areas, and random shapes. The patterned adhesive layer may have other configurations, such as lines. The adhesive patterns shown in FIG. 4 have a regular pattern, but some embodiments may be less regular. For example, lines of adhesive may be placed at or near the edges of the packaging film, leaving the center open. Alternatively, lanes of checkerboard patterns may appear at spaced intervals across the packaging film. Other configurations may be used.

FIG. 5 illustrates a schematic cross-sectional view of a package 300 including the paper-based multilayer packaging film 200 shown in FIGS. 2 and 3. The package 300 has a top surface 302 and a bottom surface 304. The package 300 may be used to wrap around a food product, such as a cheese product. When formed into a package, such as the package 300, the interior surface (not shown) is exposed to the packaged product. In one or more embodiments, the polymer layer 202 defines the interior surface (not shown) of the paper-based multilayer packaging film 200 and is exposed to the packaged product.

The package 300 may include a plurality of folds as a result of wrapping the package 300 around a cheese product. In the illustrated embodiment of FIG. 5, the package 300 includes a plurality of folds 310. The plurality of folds 310 may define any suitable shape.

For example, the wrapped package 300 having the cheese product therein may include a sticker (i.e., a label having a pressure-sensitive adhesive) on the outer surface (e.g., such as the top surface 302 and/or the bottom surface 304 of the package 300. In other embodiments, the wrapped package 300 having the cheese product therein may include a sticker on the outer surface (e.g., such as the top surface 302 and/or the bottom surface 304 of the package 300 and may then be placed in a carton box.

For each of the Inventive Examples described below, tensile characteristics including tensile stress and percent elongation of the multilayer packaging films were measured. The tensile characteristics provide an indication of runnability of the multilayer packaging films on packaging equipment.

As used herein, the term “tensile stress” refers tensile load supported by the specimen at each instant of the test, express in units of N/15 mm.

As used herein, the term “percent elongation” refers to an increase in the distance between marks produced by a tensile load and is expressed as a percentage of the distance between marks.

Each of the following documents relating to tensile characteristics and procedures are incorporated herein by reference in their entireties. It is to be noted, however, that the following documents illustrate only typical embodiments of this invention and documents that pertain to the Inventive Examples and are therefore not to be considered limiting of its scope, for the invention may admit to other equally effective embodiments.

Associated procedures: ST-083/ST-118.

The method disclosed in ISO 527-3:2018, which is entitled “Plastics—Determination of tensile properties—Part 3: Test conditions for films and sheets.” (formerly NF T 54-102, which has been cancelled).

Instructions for the MTS CRITERION model 41 device.

### Materials:

A 15 mm wide cutting template (cutter or tool with blades).

A protective glove if using the tool with blades.

Automatic force measurement apparatus: a calibrated dynamometer connected to the computer-controlled TW Elite software.

Conditioning of samples: It is desirable to carry out the measurements in an air-conditioned room after conditioning for a minimum of 1 hour at 23±2° C. and 50 to 60% relative humidity (RH).

### Operating Mode:

1. In the case of a “complex” or a “laminate,” the material must polymerize for 48 to 72 hours before testing. To accelerate polymerization, the material can be placed in an oven at 40° C. for 24 hours.
2. Cut three specimens at least 170 mm long and 15 mm wide in the running direction of the support and if requested three specimens minimum in the transverse direction.
3. Check that the cutting of the test specimens is clean without roughness (tip: to facilitate the cutting of the plastic sheets with the cutter, put the film between two sheets of paper).
4. Set the gap between the jaws of the dynamometer at 120 mm for a plastic film or a complex comprising a plastic film.
5. Insert the specimen between the jaws, stretch the specimen slightly and tighten the jaws sufficiently to prevent the support from slipping.
6. Mark a marker with a felt-tip pen flush with each jaw on the specimen to be measured to be able to observe any sliding of the support.
7. Launch the measurement, the measurement speed is 100 mm/min, when there is a break in the material, it is finished.

If the material breaks flush with the jaws, the measurement is not taken into account.

In some embodiments, the paper-based packaging film (i.e., the starting complex or lamination) may be used in a repulping process. The repulping process, as described further below, removes the paper component from the starting complex or lamination. The repulped paper content may be measured in terms of percentage of recovered cellulose fibers. The following procedure was used to determine the amount of recovered cellulose fibers after a repulping process. In some embodiments, and for each of the below Inventive Examples, a test method for separating, for the purpose of recycling materials, the paper from the extruded film or laminated with glue was performed.

This test consists of soaking the starting complex or lamination in a beaker containing hot water and mixing it to separate the paper from the film and measure the quantity of recovered paper pulp. In general, the equipment used includes:
5×5 cm cutting template
Graduated beaker that can hold 500 ml of water
Heating plate pre-set at 45° C.
Propeller stirrer with adjustable rotation speed
Thermometer to control the water temperature
Precision scale
Oven set at 70° C.

In general, the process used to measure an amount of recycled paper content includes:
1. Turn on the hot plate.
2. From the sample of about 1 m, cut ten samples of 5*5 cm.
3. Weigh the ten samples (P1).
4. Fill the beaker with 500 ml of water at 45° C.+/−2° C.
5. Place the filled beaker on the pre-set hotplate.
6. Regularly measure the temperature of the water using the thermometer.
7. Introduce the rotary support with the propeller closest to the bottom of the beaker.
8. Place the samples in the water in the beaker.
9. Start the rotation of the agitator by adjusting it (see photo 2) so as to have a rotation speed of 1100 rpm.
10. Leave to run for 15 minutes, regularly checking the water temperature.
11. At the end of the measurement, switch off the heating plate and remove the stirrer.
12. Remove the beaker and remove the ten pieces of plastic film and put them on a paper towel to drain them and put them in the oven set at 70° C. between two paper towels to dry them for 24 hours.
13. Let the ten pieces of plastic film recondition at room temperature for at least 24 hours and weigh the ten films (P2).

The multilayer packaging film may have a moisture vapor transmission rate that is optimized for the product to be packaged therein. The moisture vapor transmission rate may be measured using a dynamic testing scheme, such as ASTM F1249. In some embodiments, the multilayer packaging film has a water vapor transmission rate lower than or equal to 1,200 g/m²/day, lower than or equal to 1,000 g/m²/day, lower than or equal to 800 g/m²/day or lower than or equal to 600 g/m²/day at 38° C. and 90% RH, according to ASTM F1249. In some embodiments, the multilayer packaging film has a water vapor transmission rate greater than or equal to 50 g/m²/day, greater than or equal to 100 g/m²/day, greater than or equal to 200 g/m²/day or greater than or equal to 300 g/m²/day at 38° C. and 90% RH, according to ASTM F1249. For example, the water vapor transmission rate of the multilayer packaging film may be in the range of from 100 to 800 g/m²/day, from 50 to 600 g/m²/day, or from 300 to 1,200 g/m²/day.

Alternatively, the moisture vapor transmission rate of the multilayer packaging film may be measured using a static testing scheme, such as ASTM E398. In some embodiments, the multilayer packaging film has a water vapor transmission rate lower than or equal to 200 g/m²/day, lower than or equal to 190 g/m²/day, lower than or equal to 180 g/m²/day or lower than or equal to 170 g/m²/day, according to ASTM E398. In some embodiments, the multilayer packaging film has a water vapor transmission rate greater than or equal to 10 g/m²/day, greater than or equal to 12 g/m²/day, greater than or equal to 14 g/m²/day or greater than or equal to 16 g/m²/day, according to ASTM E398. For example, the water vapor transmission rate of the multilayer packaging film may be in the range of from 10 to 200 g/m²/day, from 10 to 180 g/m²/day, or from 16 to 190 g/m²/day.

In some embodiments, the multilayer packaging film has an air permeability in a range of from 0.1 mL/min Bendtsen to 200 mL/min Bendtsen, including all ranges and subranges therebetween, measured using the method disclosed in the international standard ISO 5636-3. An overview of Inventive Examples and the measured properties can be found in Tables 1-2.

The disclosure is now described with reference to the following Inventive Examples.

### Examples

Inventive Examples 1-7 are examples based on the paper-based packaging films having one or more layers/films as described above. The paper-based packaging films in Inventive Examples 1-7 have undergone processing such that a different level of microcuts, including a plurality of perforations that extend through a thickness of the polymer layer and/or a plurality of abrasions whose length is smaller than the thickness of the polymer layer, were applied in each of Inventive Examples 1-7. Accordingly, the general structures of the paper-based packaging films are described below.

Inventive Example 1 was produced by laminating a 40 g/m² paper component to a 8 μm oriented polypropylene (OPP) film using a water-based adhesive material having a dry basis weight of 2.4 g/m². The adhesive was applied to the polymer film and the smooth side of the paper faced the adhesive.

Inventive Example 2 was produced by laminating a 40 g/m² paper component to a 8 μm oriented polypropylene (OPP) film using a water-based adhesive material having a dry basis weight of 2.4 g/m². The adhesive was applied to the rough side of the paper.

Inventive Example 3 was produced by laminating a 40 g/m² paper component to a 8 μm oriented polypropylene (OPP) film using a water-based adhesive material having a dry basis weight of 2.4 g/m². The adhesive was applied to the smooth side of the paper.

Inventive Example 4 was produced by laminating a 40 g/m² paper component to a 8 μm oriented polypropylene (OPP) film using a water-based adhesive material having a dry basis weight of 2.4 g/m². The adhesive was applied to the smooth side of the paper.

Inventive Example 5 was produced by laminating a 40 g/m² paper component to a 8 μm oriented polypropylene (OPP) film using a water-based adhesive material having a dry basis weight of 2.4 g/m². The adhesive was applied to the smooth side of the paper.

Inventive Example 6 was produced by laminating a 40 g/m² paper component to a 8 μm oriented polypropylene (OPP) film using a water-based adhesive material having a dry basis weight of 2.4 g/m². The adhesive was applied to the smooth side of the paper.

Inventive Example 7 was produced by laminating a 40 g/m² paper component to a 8 μm oriented polypropylene (OPP) film using a water-based adhesive material having a dry basis weight of 2.4 g/m². The adhesive was applied to the polymer film and the rough side of the paper faced the adhesive.

Embodiments of the disclosure advantageously provide paper-based packaging films having high paper content. In Table 1, the different paper content of each of the Inventive Examples is shown. Table 1 shows that a predetermined minimum target of 80% paper content recovered during a repulping process, by weight, is reached for each Inventive Example.

In each of the Inventive Examples, the air permeability of the multilayer packaging film is measured using an L&W Air Permeability Meter. The L&W Air Permeability Meter measures the air permeability of a sample according to the criteria defined in SCAN-P 26:78. In accordance with SCAN-P 26:78, the sample is held between upper and lower measuring heads under a surface pressure of approximately 1 MPa. Nominal gauge pressure in the instrument is 20 kPa and the measuring surface is 50 cm². The difference of pressure between the two faces of the sample is measured at the same time as the air flow. A high-precision detector records the measured airflow.

In accordance with SCAN-P 26:78, air permeability is defined as the average value of the air flow passing through the sample, divided by the measurement surface and the pressure differential between the two sides of the paper. With SI units, we obtain the following formula “m³/s/(m²×Pa)” or, in simplified form, “μm/Pa s” the symbol commonly used for permeability. The instrument, such as the L&W Air Permeability Meter, incorporates a flow detector whose measurement range goes from 0 to 5000 ml/min. Taking into account the actual air pressure at the measuring head and that of the ambient air, the measuring range is recalculated as follows: 0.003-100 Âμm/Pa s. This makes it possible to obtain, by derivative, the following approximate measurement ranges:
2-40,000 Gurley seconds for a measuring volume of 100 ml.
0.3-8,800 ml/min Bendtsen at a measuring pressure of 1.47 kPa and for a measuring area of 10 cm²
2-1,400 SU for a measuring surface of 0.75 in diameter, i.e., 285 mm²

Recorded values and calculations shown in Table 1 are based on the following formula:

$$S = 166.7 \times u / ( 5 Q \times Lip )$$

where S is the air permeability in μm/Pa s, the flow is in in ml/min, Δp is the pressure differential between the two faces of the sample, i.e., the pressure at the level of the measuring head minus the pressure of the ambient air.

TABLE 1
Overview of paper contents and air permeability
properties of Inventive Examples

| | | Paper | Average air | Average air |
|---|---|---|---|---|
| | | content | permeability | permeability |
| | | recovered | (mL/min | (mL/min |
| | | during | Bendtsen) | Bendtsen) |
| | Paper-Based | repulping | immediately | two weeks |
| | Packaging Film | process by | after | after |
| Example | Structure | weight (%) | lamination | lamination |
| Inventive | oriented | 82% | 1.37 | 1.1 |
| Example | polypropylene | | | |
| 1 | (OPP) layer 8 | | | |
| | μm // Adhesive | | | |
| | layer 2.4 g/m² // | | | |
| | Paper 40 g/m² // | | | |
| Inventive | oriented | Not available | 3.47 | 4.1 |
| Example | polypropylene | | | |
| 2 | (OPP) layer 8 | | | |
| | μm // Adhesive | | | |
| | layer 2.4 g/m² // | | | |
| | Paper 40 g/m² // | | | |
| Inventive | oriented | 85% | 1.37 | 1.3 |
| Example | polypropylene | | | |
| 3 | (OPP) layer 8 | | | |
| | μm // Adhesive | | | |
| | layer 2.4 g/m² // | | | |
| | Paper 40 g/m² // | | | |
| Inventive | oriented | 85% | 1.21 | 1.4 |
| Example | polypropylene | | | |
| 4 | (OPP) layer 8 | | | |
| | μm // Adhesive | | | |
| | layer 2.4 g/m² // | | | |
| | Paper 40 g/m² // | | | |
| Inventive | oriented | 84% | 0.53 | 0.3 |
| Example | polypropylene | | | |
| 5 | (OPP) layer 8 | | | |
| | μm // Adhesive | | | |
| | layer 2.4 g/m² // | | | |
| | Paper 40 g/m² // | | | |
| Inventive | oriented | 82% | 2.13 | 1.2 |
| Example | polypropylene | | | |
| 6 | (OPP) layer 8 | | | |
| | μm // Adhesive | | | |
| | layer 2.4 g/m² // | | | |
| | Paper 40 g/m² // | | | |
| Inventive | oriented | 84% | 2.13 | 3.3 |
| Example | polypropylene | | | |
| 7 | (OPP) layer 8 | | | |
| | μm // Adhesive | | | |
| | layer 2.4 g/m² // | | | |
| | Paper 40 g/m² // | | | |

TABLE 2
Overview of Bond strength and elongation
properties of Inventive Examples

| | Paper-Based | Bond | Elonga- | Elongation |
|---|---|---|---|---|
| | Packaging Film | Strength | tion | Force |
| Example | Structure | (N/15 mm) | % | (N/15 mm) |
| Inventive | oriented polypropylene | 0.7 | 58.5 | 2.7 |
| Example | (OPP) layer 8 μm // | | | |
| 1 | Adhesive layer 2.4 | | | |
| | g/m² // Paper 40 | | | |
| | g/m² // | | | |
| Inventive | oriented polypropylene | 0.05 | 57.7 | 2.6 |
| Example | (OPP) layer 8 μm // | | | |
| 2 | Adhesive layer 2.4 | | | |
| | g/m² // Paper 40 | | | |
| | g/m² // | | | |
| Inventive | oriented polypropylene | 0.11 | 58.5 | 3.0 |
| Example | (OPP) layer 8 μm // | | | |
| 3 | Adhesive layer 2.4 | | | |
| | g/m² // Paper 40 | | | |
| | g/m² // | | | |
| Inventive | oriented polypropylene | 0.18 | 61.3 | 2.8 |
| Example | (OPP) layer 8 μm // | | | |
| 4 | Adhesive layer 2.4 | | | |
| | g/m² // Paper 40 | | | |
| | g/m² // | | | |
| Inventive | oriented polypropylene | 0.20 | 62.5 | 2.7 |
| Example | (OPP) layer 8 μm // | | | |
| 5 | Adhesive layer 2.4 | | | |
| | g/m² // Paper 40 | | | |
| | g/m² // | | | |
| Inventive | oriented polypropylene | 0.3 | 60.5 | 2.7 |
| Example | (OPP) layer 8 μm // | | | |
| 6 | Adhesive layer 2.4 | | | |
| | g/m² // Paper 40 | | | |
| | g/m² // | | | |
| Inventive | oriented polypropylene | 0.5 | 60.5 | 2.8 |
| Example | (OPP) layer 8 μm // | | | |
| 7 | Adhesive layer 2.4 | | | |
| | g/m² // Paper 40 | | | |
| | g/m² // | | | |

Although the disclosure herein has been described with reference to particular embodiments and Inventive Examples, it is to be understood that these embodiments and Inventive Examples are merely illustrative of the principles and applications of the present disclosure.

### EMBODIMENTS

Embodiment 1: A multilayer packaging film comprising: a polymer layer; a water-absorbing layer comprising a paper component having a basis weight in a range of from 15 g/m² to 100 g/m²; and an adhesive layer attaching the polymer layer to the water-absorbing layer, the adhesive layer having a dry basis weight in a range of from 0.1 g/m² to 6 g/m², wherein the polymer layer has a plurality of microcuts and the multilayer packaging film has an air permeability in a range of from 0.1 mL/min Bendtsen to 200 mL/min Bendtsen measured using the method disclosed in the international standard ISO 5636-3.
Embodiment 2: A multilayer packaging film comprising: a polymer layer; a water-absorbing layer comprising a paper component having a basis weight in a range of from 15 g/m² to 100 g/m²; and an adhesive layer attaching the polymer layer to the water-absorbing layer, wherein the polymer layer has a thickness in a range of from 2 μm to 10 μm, a plurality of microcuts, and the multilayer packaging film has an air permeability in a range of from 0.1 mL/min Bendtsen to 200 mL/min Bendtsen measured using the method disclosed in the international standard ISO 5636-3.
Embodiment 3: The multilayer packaging film of any previous embodiment, wherein the polymer layer comprises one or more of an oriented polyethylene (OPE) film, an oriented polypropylene (OPP) film, an oriented polyester-based polymer film, or a compostable polymer film.
Embodiment 4: The multilayer packaging film of Embodiment 3, wherein the polymer layer is a biaxially oriented polypropylene (BOPP) film.
Embodiment 5: The multilayer packaging film of any previous embodiment, wherein the adhesive layer is in direct contact with the water-absorbing layer and the polymer layer.
Embodiment 6: The multilayer packaging film of any previous embodiment, wherein the adhesive layer is patterned.
Embodiment 7: The multilayer packaging film of any previous embodiment, wherein the water-absorbing layer has a water absorption rate in a range of from 0.01 g/m² to 30 g/m² as measured using the method disclosed in the COBB test C3600.
Embodiment 8: The multilayer packaging film of any previous embodiment, wherein the basis weight of the paper component is in a range of from 20 g/m² to 60 g/m².
Embodiment 9: The multilayer packaging film of any previous embodiment, wherein the plurality of microcuts are randomly distributed.
Embodiment 10: The multilayer packaging film of any previous embodiment, wherein the plurality of microcuts include a plurality of perforations that extend through a thickness of the polymer layer and a plurality of abrasions whose length is smaller than the thickness of the polymer layer.
Embodiment 11: The multilayer packaging film of Embodiment 10, wherein the plurality of abrasions are randomly distributed.
Embodiment 12: The multilayer packaging film of any previous embodiment, wherein a total composition of the multilayer packaging film comprises greater than or equal to 80%, by weight, of the paper component.
Embodiment 13: The multilayer packaging film of Embodiment 12, wherein the total composition of the multilayer packaging film comprises greater than or equal to 90%, by weight, of the paper component.
Embodiment 14: The multilayer packaging film of any previous embodiment, wherein the multilayer packaging film is wrapped around a food product.
Embodiment 15: The multilayer packaging film of Embodiment 14, wherein the food product is a cheese product.
Embodiment 16: The multilayer packaging film of any previous embodiment, further comprising a printing layer on an outer surface of the water-absorbing layer, the printing layer facing away from the food product to be packaged.
Embodiment 17: A method of producing a multilayer packaging film, the method comprising: producing a polymer layer; abrading the polymer layer; and attaching the polymer layer to a water-absorbing layer by an adhesive lamination process to yield the multilayer packaging film, wherein the polymer layer has a plurality of microcuts and the multilayer packaging film has an air permeability in a range of from 0.1 mL/min Bendtsen to 200 mL/min Bendtsen measured using the method disclosed in the international standard ISO 5636-3, and the water-absorbing layer comprises a paper component.
Embodiment 18: The method of Embodiment 17, wherein the adhesive lamination process is performed prior to abrading the polymer layer.
Embodiment 19: The method of Embodiment 17, wherein the adhesive lamination process is performed after abrading the polymer layer.
Embodiment 20: The method of any of Embodiments 18-19, further comprising forming a printing layer on an outer surface of the water-absorbing layer, the printing layer facing away from a food product to be packaged.
Embodiment 21: The method of any of Embodiments 18-20, further comprising forming a package by wrapping the multilayer packaging film around the food product and tacking the polymer layer to the outer surface of the water-absorbing layer.
Embodiment 22: A multilayer packaging film comprising: a polymer layer having a thickness in a range of from 2 μm to 10 μm, the polymer layer facing towards a cheese product to be packaged; a water-absorbing layer comprising a paper component having a basis weight in a range of from 15 g/m² to 100 g/m², the water-absorbing layer facing away from the cheese product to be packaged; and an adhesive layer attaching the polymer layer to the water-absorbing layer, the adhesive layer having a dry basis weight in a range of from 0.1 g/m² to 6 g/m², wherein the polymer layer has a plurality of microcuts that are randomly distributed in the polymer layer, the air permeability of the multilayer packaging film is in a range of from 0.1 mL/min Bendtsen to 200 mL/min Bendtsen measured using the method disclosed in the international standard ISO 5636-3, and a total composition of the multilayer packaging film comprises 80%, by weight, of the paper component.

1. A multilayer packaging film comprising:
a polymer layer;
a water-absorbing layer comprising a paper component having a basis weight in a range of from 15 g/m² to 100 g/m²;
a printing layer on an outer surface of the water-absorbing layer, the printing layer facing away from the food product to be packaged; and
an adhesive layer attaching the polymer layer to the water-absorbing layer, the adhesive layer having a dry basis weight in a range of from 0.1 g/m² to 6 g/m²,
wherein the polymer layer has a plurality of microcuts and the multilayer packaging film has an air permeability in a range of from 0.1 mL/min Bendtsen to 200 mL/min Bendtsen measured using the method disclosed in the international standard ISO 5636-3.

2. A multilayer packaging film comprising:
a polymer layer;
a water-absorbing layer comprising a paper component having a basis weight in a range of from 15 g/m² to 100 g/m²; and
an adhesive layer attaching the polymer layer to the water-absorbing layer,
wherein the polymer layer has a thickness in a range of from 2 μm to 10 μm, a plurality of microcuts, and the multilayer packaging film has an air permeability in a range of from 0.1 mL/min Bendtsen to 200 mL/min Bendtsen measured using the method disclosed in the international standard ISO 5636-3.

3. The multilayer packaging film of claim 1, wherein the polymer layer comprises one or more of an oriented polyethylene (OPE) film, an oriented polypropylene (OPP) film, an oriented polyester-based polymer film, or a compostable polymer film.

4. The multilayer packaging film of claim 3, wherein the polymer layer is a biaxially oriented polypropylene (BOPP) film.

5. The multilayer packaging film of claim 1, wherein the adhesive layer is in direct contact with the water-absorbing layer and the polymer layer.

6. The multilayer packaging film of claim 1, wherein the adhesive layer is patterned.

7. The multilayer packaging film of claim 1, wherein the water-absorbing layer has a water absorption rate in a range of from 0.01 g/m² to 30 g/m² as measured using the method disclosed in the COBB test C3600.

8. The multilayer packaging film of claim 1, wherein the basis weight of the paper component is in a range of from 20 g/m² to 60 g/m².

9. The multilayer packaging film of claim 1, wherein the plurality of microcuts are randomly distributed.

10. The multilayer packaging film of claim 1, wherein the plurality of microcuts include a plurality of perforations that extend through a thickness of the polymer layer and a plurality of abrasions whose length is smaller than the thickness of the polymer layer.

11. The multilayer packaging film of claim 10, wherein the plurality of abrasions are randomly distributed.

12. The multilayer packaging film of claim 1, wherein a total composition of the multilayer packaging film comprises greater than or equal to 80%, by weight, of the paper component.

13. The multilayer packaging film of claim 12, wherein the total composition of the multilayer packaging film comprises greater than or equal to 90%, by weight, of the paper component.

14. The multilayer packaging film of claim 1, wherein the multilayer packaging film is wrapped around a food product.

15. The multilayer packaging film of claim 14, wherein the food product is a cheese product.

16. (canceled)

17. (canceled)

18. (canceled)

19. (canceled)

20. (canceled)

21. (canceled)

22. A multilayer packaging film comprising:
a polymer layer having a thickness in a range of from 2 μm to 10 μm, the polymer layer facing towards a cheese product to be packaged;
a water-absorbing layer comprising a paper component having a basis weight in a range of from 15 g/m² to 100 g/m², the water-absorbing layer facing away from the cheese product to be packaged; and
an adhesive layer attaching the polymer layer to the water-absorbing layer, the adhesive layer having a dry basis weight in a range of from 0.1 g/m² to 6 g/m²,
wherein the polymer layer has a plurality of microcuts that are randomly distributed in the polymer layer, the air permeability of the multilayer packaging film is in a range of from 0.1 mL/min Bendtsen to 200 mL/min Bendtsen measured using the method disclosed in the international standard ISO 5636-3, and a total composition of the multilayer packaging film comprises 80%, by weight, of the paper component.
